(19) United States
(12) Patent Application Publication
(10) Pub. No.: US 2024/0113304 A1
(43) Pub. Date: Apr. 4, 2024

(54) CATHODE FOR LITHIUM SECONDARY BATTERY, METHOD OF MANUFACTURING SAME, AND LITHIUM SECONDARY BATTERY INCLUDING SAME

(71) Applicant: SK ON CO., LTD., Seoul (KR)

(72) Inventors: Won Joon JANG, Daejeon (KR); Hyun Je KIM, Daejeon (KR); Tae Seob OH, Daejeon (KR); Seong Hwan LEE, Daejeon (KR); Seung Taek LEE, Daejeon (KR); Chan Sub LEE, Daejeon (KR)

(21) Appl. No.: 18/346,655

(22) Filed: Jul. 3, 2023

(30) Foreign Application Priority Data
Sep. 30, 2022 (KR) 10-2022-0125253

(51) Int. Cl. H01M 4/62; H01M 4/04; H01M 4/139

(52) U.S. Cl. CPC H01M 4/628; H01M 4/0404; H01M 4/0435; H01M 4/139; H01M 2004/028

(57) ABSTRACT

Disclosed is a cathode for a lithium secondary battery, which has a coating layer formed on an edge portion of a cathode plate, a method of manufacturing the cathode, and a lithium secondary battery including the cathode. The cathode includes a cathode plate and a coating layer formed at an edge portion of the cathode plate, in which the cathode plate includes a cathode current collector provided with cathode tab and a cathode active material laminated on at least one surface of the cathode current collector, and the coating layer includes a conductive polymer layer and an insulating coating layer.

### CROSS REFERENCE TO RELATED APPLICATION

The present application claims priority to Korean Patent Application No. 10-2022-0125253, filed Sep. 30, 2022, the entire contents of which is incorporated herein for all purposes by this reference.

### BACKGROUND OF THE INVENTION

### 1. Field of the Invention

The present disclosure relates to a cathode for a lithium secondary battery, a method of manufacturing the same, and a lithium secondary battery including the same. More particularly, the present disclosure relates to a cathode for a lithium secondary battery improved in rapid charging performance, a method of manufacturing the same, and a lithium secondary battery including the same.

### 2. Description of the Related Art

Recently, the demand for lithium secondary batteries has been increasing due to the market growth of electric vehicles (EVs) and electronics such as mobile devices. Therefore, research and development on the rapid charging of lithium secondary batteries are being active to increase customer satisfaction. The customers consider the rapid charging of lithium secondary batteries and the shortening of the charging time as figures that indicate the performance of lithium secondary batteries that can be repeatedly charged and discharged.

As is well known in the art, a lithium secondary battery is charged through a lithium deintercalation reaction in which lithium is oxidized and released from a cathode and a lithium intercalation reaction in which lithium is reduced and introduced into an anode. In this process, lithium precipitates, or lithium dendrites are generated at the edges of the anode, thereby negatively affects the stability of the battery. To solve this problem, a solution was suggested in which the anode was designed to be longer than the cathode, which was intended to reduce the likelihood of battery explosion or short circuiting of electrodes.

However, in the case of a secondary battery having an anode longer than a cathode, a lithium deintercalation reaction occurs on the outer end faces of the cathode and on the contact surface facing the anode during rapid high-current charging. Therefore, the edges of the anode are crowded with lithium ions released from the cathode. In addition, since the rate of gathering of lithium ions at the edges of the anode is faster than the rate of insertion of the lithium ions into the anode, lithium ions excessively accumulate at the edges of the anode, resulting in a lithium precipitation reaction at the anode. This poses a fatal problem in stability and service life of the secondary battery.

Therefore, it is desperately necessary to conduct research and development on a secondary battery having improved stability and lifespan characteristics which may be achieved by inhibiting the phenomenon in which lithium ions are released from the outer end faces of the cathode even during rapid high-current charging to control the amount of lithium ions reaching the edges of the anode and by generating a uniform-density electric field.

### SUMMARY OF THE INVENTION

The present disclosure provides a secondary battery having improved stability and lifespan characteristics by reducing precipitation of lithium ions at the edges of an anode during rapid high-current charging.

To accomplish the above objective, a cathode for a lithium secondary battery, according to the present disclosure, includes: a cathode plate including a cathode current collector having a cathode tab and a cathode active material layer formed on at least one surface of the cathode current collector; and a coating layer disposed on an edge portion of the cathode plate, in which the coating layer includes a conductive polymer layer and an insulating polymer layer.

Preferably, the coating layer may be formed on an outer end face of the edge portion of the cathode plate, and the conductive polymer layer and the insulating polymer layer are sequentially overlaid in an outward direction.

The coating layer may be disposed on the entire edge portion of the cathode plate, except for a region in which the cathode tab is provided.

Optionally, an end of the conductive polymer layer and an end of the insulating polymer layer may extend from the outer end face toward a flat surface of the cathode plate.

In the present disclosure, the conductive polymer layer may include a conductive polymer while the insulating polymer layer may include an insulating polymer.

According to the present disclosure, there is provided a method of manufacturing a cathode for a lithium secondary battery, the method including: preparing a cathode slurry by mixing a cathode active material and a binder; coating at least one surface of a cathode current collector of a cathode plate with the cathode slurry; and forming a coating layer on an edge portion of the cathode plate, in which the coating layer includes a conductive polymer layer and an insulating polymer layer.

The coating layer may be disposed in the entire edge portion of the cathode plate, except for a region in which the cathode tab is provided.

In the present disclosure, the forming of the coating layer may include: attaching a protective film to at least one surface of the cathode plate; forming the conductive polymer layer on an outer end face of the edge portion of the cathode plate; forming the insulating polymer layer on the conductive polymer layer; and removing the protective film.

In the present disclosure, the method may further include: rolling the cathode plate including the cathode active material layer formed on the cathode current collector; slitting the cathode plate to a have a predetermined size; and notching the cathode plate to form a cathode tab.

Optionally, in the present disclosure, the method may further include drying the cathode plate after removing the protective film.

Optionally, an end of the conductive polymer layer and an end of the insulating polymer layer may extend from the outer end face of the cathode plate toward a flat surface of the cathode plate.

A lithium secondary battery according to the present disclosure includes: an electrode assembly including the cathode plate described above, an anode plate, and a separator interposed between the cathode plate and the anode plate; and a pouch-type enclosing cover enclosing and sealing the electrode assembly and an electrolyte solution.

Additionally, in the present disclosure, the cathode plate and the anode plate have the same size.

The features and advantages of the present disclosure will can be more clearly understood with reference to the following detailed description and the accompanying drawings.

Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe its invention in the best way possible.

According to the present disclosure, a coating layer is formed on an edge portion of a cathode, thereby inhibiting the release of lithium ions from the edge portion of the cathode during rapid high-current charging. Therefore, it is possible to prevent the precipitation of lithium ions on the edge portion of the anode.

Accordingly, the present disclosure can provide a lithium secondary battery having improved rapid charging performance and improved stability and life span characteristics.

### BRIEF DESCRIPTION OF THE DRAWINGS

FIG. 1 is a diagram schematically illustrating a cathode of a lithium secondary battery according to the present disclosure;

FIG. 2 is a cross-sectional view illustrating various examples of an edge portion of a cathode of a lithium secondary battery according to the present disclosure;

FIG. 3 is a process diagram illustrating a method of manufacturing a cathode for a lithium secondary battery according to the present disclosure;

FIGS. 4A to 4D are conceptual diagrams illustrating sequential steps for forming a coating layer of FIG. 3;

FIG. 5 is a diagram schematically illustrating a lithium secondary battery including a cathode; and

FIG. 6 is a diagram schematically illustrating an example of an electrode assembly included in a lithium secondary battery.

### DESCRIPTION OF THE PREFERRED EMBODIMENTS

The above and other objectives, features, and advantages of the present disclosure will be more clearly understood from the following detailed description taken in conjunction with the accompanying drawings, but the present disclosure is not limited thereto. In describing the present disclosure, when the detailed description of the relevant known technology is determined to unnecessarily obscure the gist of the present disclosure, the detailed description may be omitted.

Embodiments described herein and the accompanying drawings are not intended to limit the present disclosure to particular embodiments. It should be understood that the present disclosure covers various modifications, equivalents, and/or alternatives to the embodiments.

It should be noted that regarding reference numerals denoting the components illustrated in the drawings, the same components are denoted by the same reference numerals as possible although the components are illustrated in different drawings, and similar components are denoted by similar reference numerals.

It will be understood that, although the terms “first,” “second,” etc. may be used herein to describe various elements, and these elements should not be limited by these terms. In the accompanying drawings, some components are exaggeratively illustrated, omitted, or schematically illustrated, and the size of each component in the drawings may not be the actual size.

Upon rapid charging with a high-density current, a lithium secondary battery undergoes a lithium deintercalation reaction in a cathode material and a lithium intercalation reaction in an anode material. Since lithium ions exit from the outer end faces of the cathode under the condition of a high-density current, the rate of accumulation of lithium ions at the edge portion of the anode is higher than the rate of insertion of lithium ions into the anode, resulting in lithium precipitation at the edge portion.

Accordingly, the present disclosure effectively inhibits the release of lithium ions from the outer end face of the cathode by placing a coating layer including a conductive polymer layer and an insulating polymer layer on the outer end face of the edge portion of the cathode, thereby controlling the amount of lithium ions reaching the edge portion of the anode and forming uniform density of electric fields. This results in in improvement in fast charging performance and improvement in stability and life characteristics of the secondary battery. That is, excellent electrochemical properties can be obtained.

Hereinafter, exemplary embodiments of the present disclosure will be described in detail with reference to the accompanying drawings.

As is well known to those skilled in the art, a cathode plate 100 for a lithium secondary battery is composed of a cathode current collector 100a, a cathode active material layer 100b formed on at least one surface of the cathode current collector 100a, and a cathode tab 130 protruding from one side of the cathode current collector 100a.

For the cathode current collector, any material that is highly electrically conductive and is chemically stable during charging and discharging of batteries can be used without particular limitation. For example, graphite, platinum foil, aluminum foil, copper foil, nickel foil, stainless steel foil, titanium foil, nickel foam, copper foam, a polymer substrate coated with a conductive metal, and diverse combinations thereof can be used.

The cathode active material layer may be laminated on the cathode current collector in the form of a thin film by application, drying, and rolling of a cathode slurry, which is a mixture of a cathode active material, a binder, and a solvent. As the cathode active material, any material that allows reversible intercalation and deintercalation of lithium ions can be used. In addition, any conventional cathode active materials that have been used for the cathode of a lithium secondary battery can be used without particular limitation. For example, the cathode active material may be any one material or a mixture of materials selected from among: layer-structure oxides, spinel-structure oxides, and olivine-structure phosphates, in which examples of the layer-structure oxide include: LiMO₂ (M is one or more transition metals selected from Co and Ni); LiMO₂ (M is one or more transition metals selected from Co and Ni) which is substituted with one or more heterogeneous elements selected from Mg, Al, Fe, Ni, Cr, Zr, Ce, Ti, B and Mn or coated with oxides of one or more heterogeneous selected from Mg, Al, Fe, Ni, Cr, Zr, Ce, Ti, B and Mn; LiₓNi_{α}Co_{β}M_{γ}O₂ (x is a real number satisfying 0.8≤x≤1.5, α is a real number satisfying 0.7≤α≤0.9, β is a real number satisfying 0.05≤β≤0.35, γ is a real number satisfying 0.01≤γ≤0.1, α+β+γ=1, M is an element selected from the group consisting of Mg, Sr, Ti, Zr, V, Nb, Ta, Mo, W, B, Al, Fe, Cr, Mn and Ce); and LiₓNiₐMn_{b}Co_{c}M_{d}O₂ (x is a real number satisfying 0.9≤x≤1.1, a is a real number satisfying 0.3≤a≤0.6, b is a real number satisfying 0.3≤b≤0.4, c is a real number satisfying 0.1≤c≤0.4, d is a real number satisfying 0≤d≤0.4, a+b+c+d=1, and M is one or more elements selected from Mg, Sr, Ti, Zr, V, Nb, Ta, Mo, W, B, Al, Fe, Cr and Ce), examples of the spinel-structure oxide include LiₐMn₂₋ₓMₓO₄ (M is one or more elements selected from Al, Co, Ni, Cr, Fe, Zn, Mg, B, and Ti, a is a real number satisfying 1≤a≤1.1, and x is a real number satisfying 0≤x≤0.2) and Li₄Mn₅O₁₂, and the olivine-structure phosphate is, for example, LiMPO₄ (M is Fe, Co, or Mn).

For example, the binder is a component that aids in binding the cathode active material to a conductive material and in bonding the cathode active material to the cathode current collector.

The cathode slurry used to form the cathode active material layer may optionally further include a conductive material and/or a thickener. The conductive material is used to secure the conductivity between the cathode active material and the cathode current collector. As the conductive material, any existing electron conductive material that does not cause chemical changes in battery cells can be used without particular limitation. For example, the conductive material may be selected from the group consisting of, but not limited to, natural graphite, artificial graphite, acetylene black, Ketjen black, channel black, Furnace black, lamp black, thermal black, fluorocarbon, aluminum powder, nickel powder, titanium oxide, carbon black, carbon fiber, and carbon nanotube, and diverse combinations thereof. In addition, the thickener is used to provide viscosity to the cathode slurry so that the coatability and dispersibility of the cathode slurry can be improved. As the thickener used in the present disclosure, any typical thickener that has been used in the art of secondary batteries or has been known to those skilled in the art can be used.

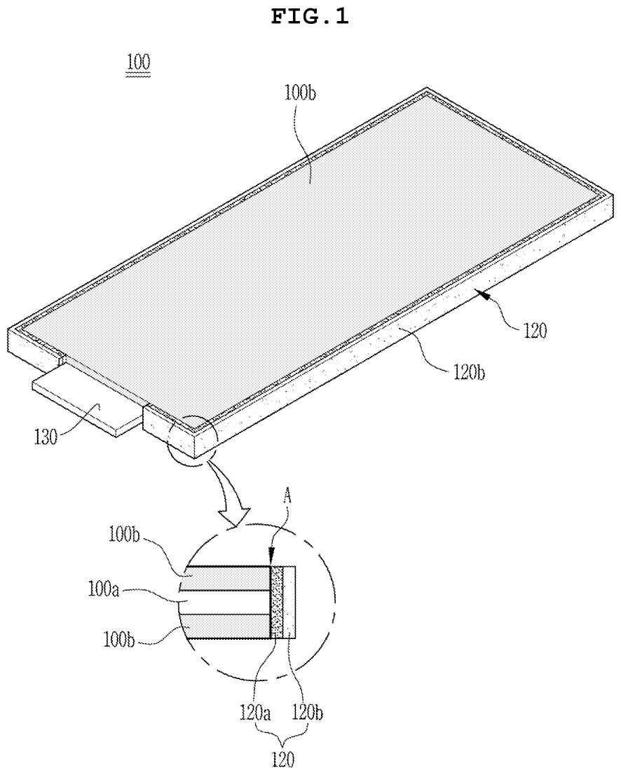

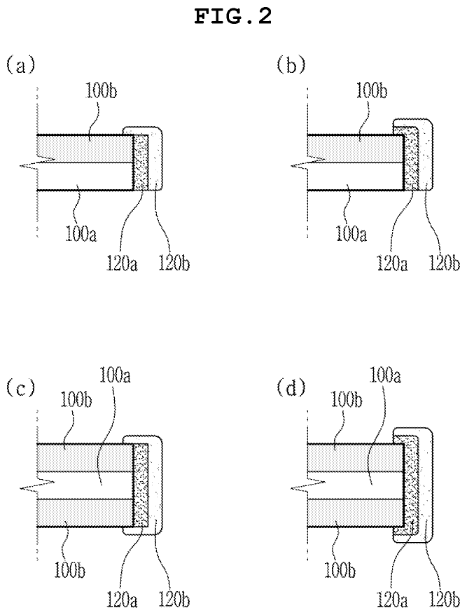

As described above, the cathode for a lithium secondary battery, according to the present disclosure, is configured to inhibit the precipitation of lithium ions at an edge portion of an anode plate during rapid charging. To this end, as illustrated in FIGS. 1 to 2, the cathode for a lithium secondary battery, according to the present disclosure, includes: a cathode plate 100 including a cathode current collector and a cathode active material layer disposed on the cathode current collector; and a coating layer 120 formed on an edge portion of the cathode plate 100. In addition, the cathode plate 100 may have a cathode tab 130 protruding outward from an uncoated portion of the cathode current collector, in which the uncoated portion is a portion in which the cathode active material is not present.

The coating layer 120 is formed on the entire edge portion of the cathode plate 100, except for a region in which the cathode tab is provided (see FIG. 1). Alternatively, the coating layer 120 is formed at a local area of the edge portion of the cathode plate 100.

Preferably, the coating layer 120 includes a conductive polymer layer 120a and an insulating polymer layer 120b. More preferably, according to the present disclosure, the conductive polymer layer 120a and the insulating polymer layer 120b may be sequentially formed on an outer end face A of the edge portion of the cathode plate 100 in an outward direction.

Specifically, the conductive polymer layer 120a inhibits the movement of lithium ions during rapid charging but facilitates the movement of electrons. That is, the conductive polymer layer 120a minimizes the increase in resistance at the edge portion of the cathode plate, thereby preventing the decrease in capacity of the cathode material and suppressing lithium precipitation. The conductive polymer layer 120a may be made of a conductive polymer that promotes the movement of electrons and does not react with the cathode active material or electrolyte. For example, the conductive polymer may be one or more selected from polyacetylene-based polymers, polypyrrole-based polymers, polythiophene-based polymers, polyaniline-based polymers, polyphenylene sulfide polymers, polyphenylene vinylene polymers, and polythiophene-based polymers, and preferably may be polyethylene dioxythiophene (PEDOT).

The insulating polymer layer 120b is disposed on the conductive polymer layer 120a. The insulating polymer layer 120b inhibits the movement of electrons and lithium ions, thereby preventing lithium ions escaping from the edge portion of the cathode plate. Therefore, the insulating polymer layer 120b controls the amount of lithium ions reaching the edge portion of the anode plate during rapid charging, thereby forming a uniform-density electric field and ensuring the electrochemical performance and lifespan characteristics of battery cells. The insulating polymer layer 120b may be made of an insulating polymer that inhibits the movement of electrons and lithium ions and does not react with the cathode active material or electrolyte. For example, the insulating polymer may be one material or a combination of materials selected from polyurethane-based polymers, polyolefn-based polymers, and the like. Specifically, the insulating polymer may be one material or a combination of materials selected from: fluorine-based polymers such as spandex, polyethylene, polypropylene-based polymers, polyvinylidene fluoride (PVDF), polytetrafluoroethylene, polyhexafluoropropylene, polychlorotrifluoroethylene, polyhexafluoroisobutylene, polyperfluorobutylethylene, and polyperfluoromethyl vinyl ether; and SMC/SBR-based elastomers.

In the present disclosure, the thickness of the conductive polymer layer 120a may be in the range of from 20 μm to 50 μm, and the thickness of the insulating polymer layer 120b may be in the range of from 30 μm to 50 μm.

FIG. 2 is a cross-sectional view illustrating the stacked shape of the coating layer at the edge portion of the cathode plate. FIG. 2 illustrates modifications of the coating layer of FIG. 1.

In FIG. 2, (a) shows that the coating layer 120 (120a+120b) is formed on at least a portion of the outer end face of the cathode plate 100. The conductive polymer layer 120a and the insulating polymer layer 120b are sequentially stacked in an outward direction, on the outer end face of the cathode plate 100. Specifically, one end of the insulating polymer layer 120b bends and extends toward a flat surface of the cathode plate, on which the cathode active material layer is disposed so that the insulating polymer layer 120b is arranged to partially cover the edge portion of the cathode plate and to cover the conductive polymer layer 120a.

In FIG. 2, (b) shows that the coating layer 120, 120a, and 120b are formed on at least a portion of the outer end face of the cathode plate 100, in which the conductive polymer layer 120a and the insulating polymer layer 120b are sequentially stacked on the outer end face of the cathode plate 100. One end of the conductive polymer layer 120a bends and extends toward a flat surface of the cathode plate, on which the cathode active material layer is disposed, thereby covering the outer end face and a portion of the edge portion of the cathode plate. In addition, the insulating polymer layer 120b is disposed to cover the conductive polymer layer 120a.

In FIG. 2, (c) shows that the coating layer 120 (120a+120b) is formed on at least a portion of the outer end face of the cathode plate 100, in which the conductive polymer layer 120a and the insulating polymer layer 120b are sequentially stacked, in an outward direction, on the outer end face of the cathode plate 100. Specifically, both ends of the insulating polymer layer 120b bend and extend toward respective flat surfaces of the cathode plate, on which the cathode active material layer is disposed, thereby covering the conductive polymer layer 120a and a portion of the edge portion of the cathode plate.

In addition, in FIG. 2, (d) shows that the coating layer 120 (120a+120b) is formed on at least a portion of the outer end face of the cathode plate 100, in which the conductive polymer layer 120a and the insulating polymer layer 120b are sequentially stacked, in an outward direction, on the outer end face of the cathode plate 100. Both ends of the conductive polymer layer 120a bend and extend toward respective flat surfaces of the cathode plate, on which the cathode active material layer is disposed, thereby covering the outer end face and a portion of the edge portion of the cathode plate. In addition, the insulating polymer layer 120b is disposed to cover the conductive polymer layer 120a.

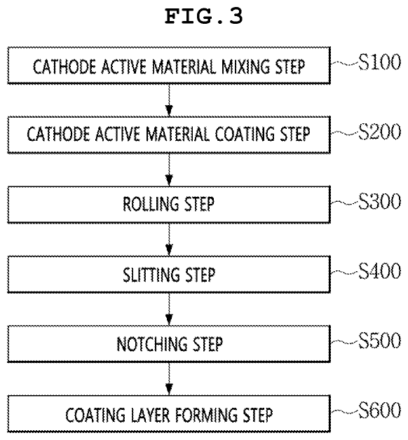

FIG. 3 is a process diagram illustrating a method of manufacturing a cathode for a lithium secondary battery, according to the present disclosure.

A method of manufacturing a cathode for a lithium secondary battery, according to the present disclosure, features that a coating layer composed of a conductive polymer layer and an insulating polymer layer is formed on an edge portion of a cathode plate. The method includes a cathode active material mixing step S100, a cathode active material coating step S200, a rolling step S300, a slitting step S400, a notching step S500, and a coating layer forming step S600.

First, the cathode active material mixing step S100 is a process of mixing a cathode slurry including a cathode active material, which is used to form a cathode active material layer 100b (see FIG. 2) on one surface or each of both surfaces of a cathode current collector 100a (see FIG. 2).

As is well known, the cathode slurry is prepared in the form of a paste by mixing a cathode active material, a binder, and a solvent. Optionally, the cathode slurry may further include a conductive material and/or a thickener.

When preparing the cathode slurry, the solvent may be a material that allows the cathode active material and the conductive material to be uniformly dispersed. The solvent can easily evaporate to facilitate drying.

The paste-type cathode slurry is applied to at least one surface of a cathode current collector (S200). The cathode current collector may be composed of a coated portion that is coated with the cathode active material and an uncoated portion that is not coated with the cathode active material.

The cathode slurry is uniformly applied to the cathode current collector which is, for example, an aluminum foil. The cathode plate, which is the cathode current collector coated with the cathode slurry, is sufficiently dried.

After one surface or both surfaces of the cathode current collector are coated with the cathode slurry, the cathode plate undergoes the rolling S300 step in which the cathode plate is passed between two roll processes, which makes the cathode plate have a predetermine thickness. The cathode plate is prepared by forming the cathode active material layer on the cathode current collector, and the rolling step increases the capacitance density of the electrode and increases the adhesion between the cathode current collector and the cathode active material.

When the rolling step S300 is completed, the cathode plate undergoes the slitting step S400 in which the cathode plate is cut to have a predetermined size.

The cathode plate having undergone the slitting subsequently undergoes the notching S500 by which the uncoated portion is notched to form a cathode tab. For the notching, a notching device is used. Through the notching step, unnecessary portions of the cathode plate are removed according to the cell shape, so that the cathode plate with the cathode tab is prepared.

Finally, the present disclosure includes Step S600 of forming a coating layer 120 (see FIG. 1) on an edge portion of the cathode plate. In the present disclosure, the edge portion of the cathode plate is covered with the coating layer 120, thereby effectively preventing the release of lithium ions from the outer end faces of the cathode and suppressing an increase in electric resistance of the cathode material, even during rapid charging.

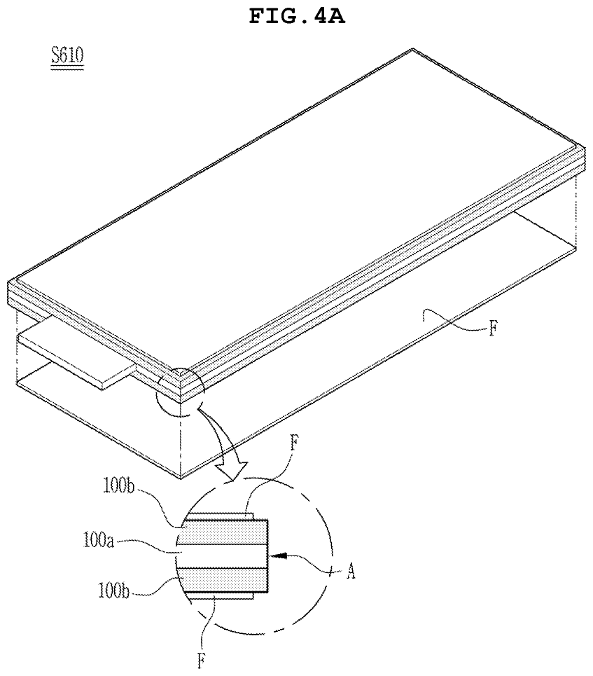

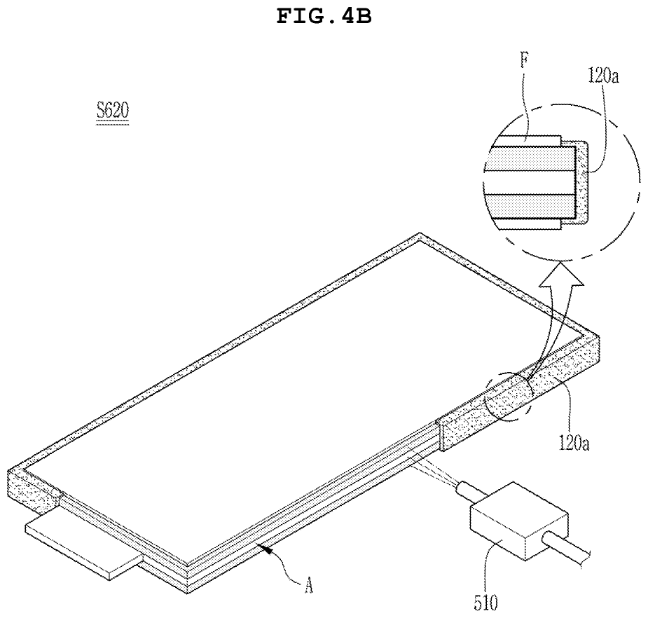

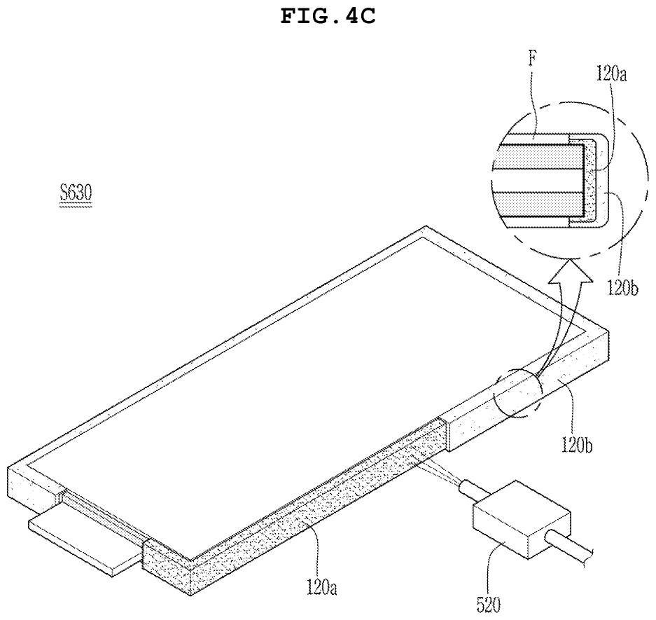

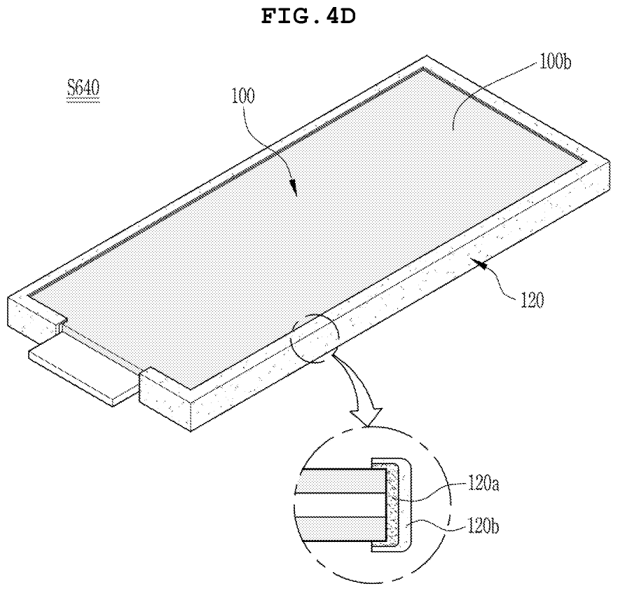

The coating layer forming step S600 will be described step by step with reference to FIGS. 4A to 4D.

Before laminating the coating layer along the edge portion of the cathode plate 100, as illustrated in FIG. 4A, a protective film F is attached to the principle flat surfaces of the cathode plate (Step S610).

The material of the protective film F is not particularly limited if it has chemical resistance when it is in contact with a conductive dispersion solution or an insulating dispersion solution. For example, one material or a combination of materials selected from the following may be used: poly ethylene terephthalates (PETs), polyvinyl chlorides (PVCs), polycarbonates (PCs), nylon polymers, phenyleneoxides (PPOs), polyoxymethylene (POMs), polytetrafluoroethylenes (PTFEs), polyimides, polyvinyl alcohols (PVAs), TACs, polyvinyl butyral (PVBs), poly methyl methacrylates (PMMAs), polyethylene naphthalates (PENs), acrylonitrile butadiene styrene (ABS) copolymers, polybutylene terephthalates (PBTs), polychlorotrifluoroehtylenes (PCTFEs), polyvinyl fluorides (PVFs), perfluoroalkoxy alkanes (PFAs), fluorinated ethylene-propylenes (FEPs), poly ethylene-co-tetrafluoroethylenes (ETFEs), perfluoropolyethers (PFPEs), polyethylenes (PEs), polypropylenes (PPs) polystylenes (PSs), polyethersulfones (PESs), polyetherimides (PEIs), polyphenylene sulfides (PPSs), polyphthalamides (PPAs), polysulfones (PSFs), syndiotactic polystyrene (SPSs), polymethyl pentenes (PMPs), polyphenyl ethers (PPEs), and polydimethyl siloxanes (PDMSs).

Here, the conductive dispersion solution is a solution containing a conductive polymer dispersed by a dispersant, and the insulating dispersion solution is a solution containing an insulating polymer dispersed by a dispersant.

Preferably, the protective film F can be easily attached to and detached from the cathode active material layer 100b formed on one or both surfaces of the cathode plate 100.

As illustrated in FIG. 4B, the present disclosure may include Step S620 of forming the conductive polymer layer 120a by applying the conductive dispersion solution to the edge portion of the cathode plate 100 through a first spray nozzle 510. Preferably, the conductive dispersion solution may be applied to the outer end face A of the edge portion of the cathode plate 100. The conductive dispersion solution may be sprayed through the first spray nozzle so as to form a coating layer with a uniform thickness on the edge portion of the cathode plate. In the spraying of the conductive dispersion solution, the conductive dispersion solution may be rapidly and evenly sprayed on the outer end face A of the cathode plate while changing the position of the first spray nozzle. Optionally, according to the present disclosure, the conductive dispersion solution may be sprayed onto a portion of the edge as well as the outer end face. The conductive polymer layer needs to be applied to shield the end face of an edge portion as described above.

In other words, the conductive polymer layer 120a is formed on the entire edge portion of the cathode plate 100, except for a region in which the cathode tab is provided.

After the completion of the formation of the conductive polymer layer 120a, as illustrated in FIG. 4B, the present disclosure may include Step S630 of forming the insulating polymer layer 120b by spraying the insulating dispersion solution to the edge portion of the cathode plate 100 through a second spray nozzle 520. Preferably, the insulating dispersion solution may be sprayed toward the outer end face A of the edge portion of the cathode plate 100. The insulating polymer layer may be formed to have a shape that can cover the conductive polymer layer.

Thus, the insulating polymer layer 120b may cover the conductive polymer layer 120a and a portion of the edge portion.

In the case where the edge portion of the cathode plate is not coated with the conductive polymer layer but is coated with only the insulating polymer layer, since the insulating polymer layer can be laminated on a principal surface of the cathode plate as well as the surface of the edge portion of the cathode plate. In this case, diffusion into the polymer layer may occur, thereby posing the problems of decreasing electrical conductivity, increasing the resistance of a cathode material, and decreasing a specific capacity.

The insulating dispersion solution may be sprayed through the second spray nozzle so as to form a coating layer with a uniform thickness on the edge portion of the cathode plate. In the spraying of the insulating dispersion solution, the insulating dispersion solution may be rapidly and evenly sprayed on the conductive polymer layer 120a while changing the position of the second spray nozzle. Optionally, according to the present disclosure, the insulating dispersion solution may be sprayed onto a portion of the edge as well as the outer end face.

Of course, the insulating polymer layer 120b is formed on the entire edge portion of the cathode plate 100, except for a region in which the cathode tab is provided.

In addition, when continuously performing the steps S620 and S630 described above, i.e., in the process of forming the insulating polymer layer 120b on the conductive polymer layer 120a, the present disclosure may form a mixed layer (not illustrated) in which the conductive polymer and the insulating polymer coexist, at the boundary between the conductive polymer layer 120a and the insulating polymer layer 120b. The mixed layer improves the bonding between the conductive polymer and the insulating polymer. This inhibits the peeling in the battery when charging and discharging are repeated many times, resulting in improvement in durability of the battery cell.

The present disclosure prevents the conductive polymer layer and/or the insulating polymer layer from being formed on the cathode active material layer 100b by using the protective film F when spraying the conductive dispersion solution through the first spray nozzle 510 and the insulating dispersion solution through the second spray nozzle 520.

The present disclosure includes Step S640 of removing the protective film F, thereby exposing the cathode active material layer 100b of the cathode plate 100, so that the cathode active material serves to supply lithium ions in the lithium secondary battery.

Optionally, according to the present disclosure, after the protective film is removed, the cathode plate is dried. Preferably, the cathode plate is vacuum-dried so that the solvent of the dispersion solution is removed. Thus, a coating layer 120 including a conductive polymer layer 120a and an insulating polymer layer 120b sequentially laminated in an outward direction is formed on the edge portion of the cathode plate.

The present disclosure provides a pouch-type lithium secondary battery including a cathode plate having a coating layer at an edge portion thereof.

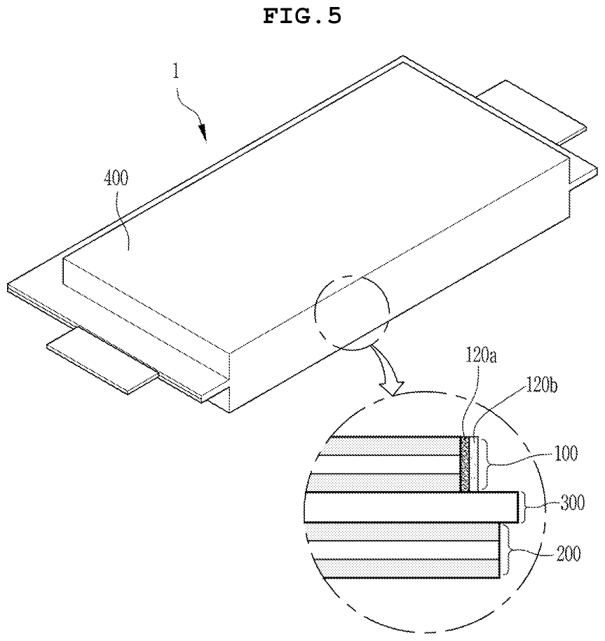

As illustrated in FIG. 5, a lithium secondary battery 1 includes an electrode assembly and a pouch-type enclosing cover 400 enclosing and sealing the electrode assembly and an electrolyte solution. Here, the electrode assembly is a power generation element composed of a cathode plate 100, an anode plate 200, and a separator 300 interposed between the cathode plate 100 and the anode plate 200.

The cathode plate 100 is formed by applying a cathode active material to a cathode current collector as described above, and the anode plate 200 is formed by applying an anode active material to an anode current collector.

In the electrode assembly, the cathode plate 100 and the anode plate 200 are disposed to face each other. The cathode plate and the anode plate may be arranged such that the flat principal surfaces thereof face each other, with the separator 300 interposed therebetween. The separator 300 prevents direct contact between the cathode plate and the anode plate. The anode plate and the separator are existing ones well known in the art, and thus a detailed description thereof will be omitted herein.

As illustrated in the circle of FIG. 5, the electrode assembly housed in the pouch-type enclosing cover is structured such that the cathode plate 100 is stacked on the anode plate 200, with the separator 300 interposed therebetween. In this case, a coating layer 120 composed of a conductive polymer layer 120a and an insulating polymer layer 120b is disposed on an outer end face A at an edge portion of the cathode plate 100.

Generally, a lithium secondary battery has been known to suffer decrease in charge/discharge efficiency due to the growth of lithium dendrites. In order to inhibit the formation of lithium dendrites, an anode plate with an increased surface area is used to achieve a desired level of battery performance. To this end, the anode plate 200 is designed to be longer than the cathode plate 100.

In the present disclosure, the lithium secondary battery has a dual-layered coating layer 120 composed of a conductive polymer layer 120a and an insulating polymer layer 120b, at the edge portion of the cathode plate. This structure effectively suppresses the release of lithium ions from the outer end face of the cathode plate 100 during rapid charging, thereby controlling the amount of lithium ions reaching the edge portion of the anode plate 200 and forming a uniform density of electric fields.

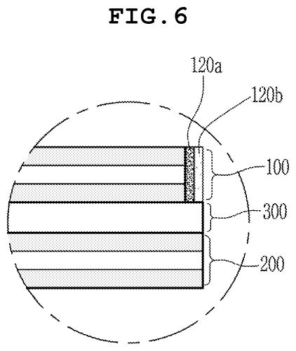

FIG. 6 is a schematic view illustrating another example of an electrode assembly which is the main part of the lithium secondary battery illustrated in FIG. 5. The lithium secondary battery according to the present disclosure can effectively suppress the release of lithium ions from the outer end face of the cathode plate by using a dual-layered coating layer 120 (120a+120b) provided on an outer end face of a cathode plate.

Due to these characteristics, the present disclosure allows that the length of the cathode plate 100 is equal to the length of the anode plate 200. Alternatively, the length of the cathode plate 100, the length of the anode plate 200, and the length of the separator 300 may be the same. Even with this size settings, a desired level of battery performance can be obtained.

This is beneficial in terms of preventing the anode plate 200 and/or the separator 300 from being bent in the process of encasing the electrode assembly with the pouch-type enclosing cover. In addition, the electrode assembly can be compactly accommodated in the pouch-type enclosing cover without gap between the electrode assembly and the inner surface of the pouch-type enclosing cover 400 (see FIG. 5). Therefore, it is possible to improve the energy density (i.e., volumetric energy density) of a lithium secondary battery. In addition, according to the present disclosure, it is possible to reduce the size of the anode plate such that the anode plate and the cathode plate have the same size, thereby reducing the manufacturing cost of the anode plate.

Herein above, the present disclosure has been described in detail with reference to specific embodiments. Embodiments are intended to illustrate the present disclosure in detail, and the present disclosure is not limited thereto. It will be apparent to those skilled in the art that modifications thereto or improvements thereof are possible within the technical spirit of the present disclosure.

All simple modifications and alterations of the present disclosure fall within the scope of the present disclosure, and the specific protection scope of the present disclosure will be clearly defined by the appended claims.

What is claimed is:

1. A cathode for a lithium secondary battery, the cathode comprising:
a cathode plate comprising a cathode current collector with a cathode tab and a cathode active material layer provided on at least one surface of the cathode current collector; and
a coating layer provided at an edge portion of the cathode plate,
wherein the coating layer comprises a conductive polymer layer and an insulating polymer layer.

2. The cathode of claim 1, wherein the coating layer is formed by sequentially providing the conductive polymer layer and the insulating polymer layer on an outer end face of the edge portion of the cathode plate in an outward direction.

3. The cathode of claim 1, wherein the coating layer is disposed at the edge portion of the cathode plate, except for a region in which the cathode tab is provided.

4. The cathode of claim 1, wherein an end of the conductive polymer layer and an end of the insulating polymer layer extend from the outer end face of the cathode plate toward a flat surface of the cathode plate.

5. The cathode of claim 1, wherein the conductive polymer layer comprises a conductive polymer and the insulating polymer layer comprises an insulating polymer.

6. A method of manufacturing a cathode for a lithium secondary battery, the method comprising:
preparing a cathode slurry by mixing a cathode active material and a binder;
applying the cathode slurry to at least one surface of a cathode current collector to produce a cathode plate; and
forming a coating layer at an edge portion of the cathode plate,
wherein the coating layer comprises a conductive polymer layer and an insulating polymer layer.

7. The method of claim 6, wherein the coating layer is disposed at the edge portion of the cathode plate, except for a region in which a cathode tab is provided.

8. The method of claim 6, wherein the forming of the coating layer comprises:
attaching a protective film to the at least one surface of the cathode plate;
forming the conductive polymer layer on an outer end face of the edge portion of the cathode plate;
forming the insulating polymer layer on the conductive polymer layer; and
removing the protective film.

9. The method of claim 6, further performing:
between the applying of the cathode slurry and the forming of the coating layer,
rolling the cathode plate obtained by applying the cathode active material to the cathode current collector;
slitting the cathode plate to have a predetermined size; and
notching the cathode plate to form a cathode tab.

10. The method of claim 8, further performing drying the cathode plate after the removing of the protective film.

11. The method of claim 6, wherein an end of the conductive polymer layer and an end of the insulating polymer layer extend from the outer end face of the cathode plate toward a flat surface of the cathode plate.

12. A lithium secondary battery comprising:
an electrode assembly comprising the cathode plate according to claim 1, an anode plate, and a separator interposed between the cathode plate and the anode plate; and
a pouch-type enclosing cover configured to enclose and seal the electrode assembly and an electrolyte.

13. The lithium secondary battery of claim 12, wherein the cathode plate and the anode plate have the same size.

14. A lithium secondary battery comprising:
an electrode assembly comprising the cathode plate according to claim 2, an anode plate, and a separator interposed between the cathode plate and the anode plate; and
a pouch-type enclosing cover configured to enclose and seal the electrode assembly and an electrolyte.

15. The lithium secondary battery of claim 14, wherein the cathode plate and the anode plate have the same size.

16. A lithium secondary battery comprising:
an electrode assembly comprising the cathode plate according to claim 3, an anode plate, and a separator interposed between the cathode plate and the anode plate; and
a pouch-type enclosing cover configured to enclose and seal the electrode assembly and an electrolyte.

17. The lithium secondary battery of claim 16, wherein the cathode plate and the anode plate have the same size.

18. A lithium secondary battery comprising:
an electrode assembly comprising the cathode plate according to claim 4, an anode plate, and a separator interposed between the cathode plate and the anode plate; and
a pouch-type enclosing cover configured to enclose and seal the electrode assembly and an electrolyte.

19. The lithium secondary battery of claim 18, wherein the cathode plate and the anode plate have the same size.

20. A lithium secondary battery comprising:
an electrode assembly comprising the cathode plate according to claim 5, an anode plate, and a separator interposed between the cathode plate and the anode plate; and
a pouch-type enclosing cover configured to enclose and seal the electrode assembly and an electrolyte.

21. The lithium secondary battery of claim 20, wherein the cathode plate and the anode plate have the same size.
